(19) United States
(12) Patent Application Publication
(10) Pub. No.: US 2011/0045290 A1
(43) Pub. Date: Feb. 24, 2011

(54) Adhesive Sheet

(75) Inventors: Jun Maeda, Munich (DE); Keiko Tanaka, Gunma (JP); Yoji Wakayama, Saitama (JP)

Correspondence Address: CAHN & SAMUELS LLP, 1100 17th STREET NW, SUITE 401, WASHINGTON, DC, 20036, US

(73) Assignee: LINTEC CORPORATION, Tokyo (JP)

(21) Appl. No.: 12/920,325

(22) PCT Filed: Mar. 2, 2009
(86) PCT No.: PCT/JP2009/053863

§ 371 Date: Aug. 31, 2010

(30) Foreign Application Priority Data
Mar. 3, 2008 (JP) 2008-051857

(51) Int. Cl. C09J 7/02; B32B 38/10; B32B 38/04; B32B 27/00

(52) U.S. Cl. 428/355 AC; 156/154; 156/250

(57) ABSTRACT

An adhesive sheet includes a substrate and an energy ray curable adhesive layer formed thereon The energy ray curable adhesive layer includes an acrylic adhesive polymer having a weight average molecular weight of not less than 100,000, and a polymerizable group is bonded to the acrylic adhesive polymer through a polyalkyleneoxy group. The energy ray curable adhesive sheet improves the breaking elongation and the expandability of the cured adhesives, thereby preventing the glue residue on the adherend of the sheet after release.

### FIELD OF THE INVENTION

The present invention relates to adhesive sheets used in the processing of electronic components such as semiconductor wafers. In particular, the invention relates to adhesive sheets that are suitably used to protect the circuit surface when semiconductor wafers are ground to extreme thinness or to hold semiconductor wafers during the dicing of the wafers.

### BACKGROUND OF THE INVENTION

After circuits are formed on the surface, a semiconductor wafer as a typical electronic component undergoes a backgrinding which controls the wafer thickness by carrying out a grinding process to the back side of the wafer, and a dicing in which the wafer is separated into a predetermined chip size.

In the backgrinding, an adhesive sheet called a backgrind tape is applied to the circuit surface of the wafer to protect the circuits. In the wafer dicing, an adhesive sheet called a dicing tape is applied to the backside of the wafer to prevent the chips from being scattered.

The adhesive sheets, in particular the backgrind tapes, used in the processing of electronic components are required:

to prevent damages to the circuits or the wafers;

to release without residual adhesive (glue residue) on the circuits;

to prevent the penetration of grinding water used in the backgrinding to wash away grinding dusts or to remove heat generated by the grinding, into the circuit surface, of grinding water used in the backgrinding to wash away grinding dusts or to remove heat generated by the grinding; and

to keep the thickness of wafers precisely after the grinding.

Also, the requirements for the dicing tapes include:

that the tapes hold the wafer with sufficient adhesive force during the dicing;

that the tapes have sufficient expandability for spacing in between the chips after the dicing;

that the tapes easily release the chips from the dicing tape during the pickup of the chips; and

that no residual adhesive remains to the backside of the chips that are picked up.

As for such adhesive, the adhesive sheets provided with an energy ray curable adhesive layer, on the substrate formed by a resin film, which is curable by the energy rays such as UV rays are widely used. According to such energy ray curable adhesive sheets, it can hold a wafer (chips) with strong adhesive force during the wafer backgrinding and dicing, thus can prevent the grinding water from penetrating into the circuit surface or the scattering of chips. Also, after the backgrinding or dicing is completed, the adhesive layer is irradiated with energy rays and thereby cured to reduce the adhesive force, which permitts the wafer (chips) to be released therefrom without residual adhesive.

As for the energy ray curable adhesive, the adhesives in which an energy ray curable resin of relatively low molecular weight and a photopolymerization initiator are mixed with an acrylic adhesive polymer are known. However, because the mixing level of the components is necessary uniform and the adhesives contain low-molecular weight substances, the energy ray irradiation may results in incomplete curing of the adhesives or low-molecular weight substances may be left unreacted. As a result, in some cases, the adhesives remained on the wafer (chips) or the low-molecular weight substances contaminated the wafer (chips).

To solve these problems, a wafer-processing adhesive sheet comprising, an energy ray curable adhesive layer formed by the energy ray polymerizable adhesive polymer introducing the energy ray polymerizable group into the molecule of the adhesive polymer by reacting a compound including an energy ray polymerizable group with an acrylic adhesive polymer, (hereinafter, such adhesives are also referred to as the “adduct adhesives”), and a photopolymerization initiator. According to the adduct adhesives, the energy ray polymerizable groups are dispersed uniformly in the adhesive layer and also the amount of low-molecular weight substances is scarce, thereby it can reduce the likelihood of insufficient curing or the contamination by the low-molecular weight substances.

### [Patent Document 1] JP-A-H09-298173

### DISCLOSURE OF THE INVENTION

### Problems to be Solved by the Invention

Recently, due to the higher density of the circuit design, the formation of a large number of irregularities caused by minute wires or circuit patterns are formed on the wafer surface. As a result, even the wafer-processing adhesive sheets using the adduct adhesive have a glue residue problem in some instances. The problem is thought to be caused as a result of the adhesive being filled in the minute gaps between the circuit surface and captured in the gaps after the adhesive is cured, then it is left on the circuit surface when the cured object is torn by the pulling force for releasing. Further, in the wafer-processing adhesive sheets using the adduct adhesive, the adhesive layer becomes brittle after cured which may lower the expandability. In particular, the adhesive sheets are often torn when they are expanded at a high expansion ratio in order to facilitate the pickup of the chips after dicing.

Therefore, by improving the breaking elongation of the cured adhesives may have possibility that even when the cured adhesives are expanded for releaseing, it can extend without breaking and are freed from being captured in the gaps, and can be released from the circuit surface together with the surrounding cured adhesives, thus the probability of glue residue can be reduced. Further, the tearing of an adhesive sheet from a rupture portion in a cured adhesive can be prevented.

That is, an object of the present invention is, in the adhesive sheets for processing electronic components used as backgrind tapes or dicing tapes, particularly in the energy ray curable adhesive sheets using an adduct adhesive, to improve breaking elongation of the cured adhesives, thereby providing high expandability, and to prevent the glue residue on the wafer (chip) after the adhesive sheets are released. In the present invention, the term tapes includes adhesive tapes and adhesive sheets, and the term sheets includes adhesive sheets and adhesive tapes.

### Means for Solving the Problems

The summary of the present invention aiming to achieve the above object is as follows.

(1) An adhesive sheet comprising a substrate and an energy ray curable adhesive layer formed thereon, wherein:

the energy ray curable adhesive layer comprises an acrylic adhesive polymer having a weight average molecular weight of 100,000 or more, and a polymerizable group is bonded to the acrylic adhesive polymer through a polyalkyleneoxy group.

(2) The adhesive sheet described in (1), wherein the acrylic adhesive polymer has a polymerizable group-containing polyalkyleneoxy group of Formula (1) below bonded to a side chain;

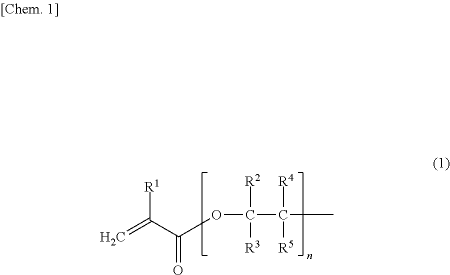

In said formula, R¹ is a hydrogen atom or a methyl group, R² to R⁵ are each independently a hydrogen atom or an alkyl group of carbon atom 1 to 4, n is an integer of 2 or greater, and a plurality of R² to R⁵ may be the same or different from each of.

(3) The adhesive sheet described in (2), wherein 1×10²² to 1×10²⁴ polymerizable group-containing polyalkyleneoxy groups are contained per 100 g of the acrylic adhesive polymer.

(4) The adhesive sheet described in (1), wherein the energy ray curable adhesive layer after the curing has a breaking elongation of 16% or more.

(5) A method of backgrinding electronic components, comprising attaching an electronic component to the energy ray curable adhesive layer of the adhesive sheet described in (1), and performing the backgrinding to the electronic component.

(6) A method of dicing electronic components, comprising attaching an electronic component to the energy ray curable adhesive layer of the adhesive sheet described in (1), and performing the dicing to the electronic component.

### EFFECTS OF THE INVENTION

According to the present invention, in the energy ray curable adhesive sheets using the adduct adhesive, the breaking elongation of the cured adhesive is improved. As a result the expandability is improved as well. Also, even if it is an electronic component having numerous irregularities on the surface due to the fine wires or circuit patterns, when the adhesive sheet is released from the electronic component after the curing of the adhesive layer, the cured adhesive can extends without being broken while being pulled and can be freed from the gaps; hence together with the surrounding cured adhesive, it can be released from the circuit surface with reduced probability of glue residue.

### PREFERRED EMBODIMENTS FOR CARRYING OUT THE INVENTION

Hereinbelow, preferred embodiments of the present invention including best modes will be described in detail. The adhesive sheets of the invention will be described below focusing on the embodiments in which the adhesive sheets are used for the processing of the semiconductor wafers as electronic components. However, the application field of the adhesive sheets of the invention is not limited to semiconductor wafers.

An adhesive sheet according to the present invention includes a substrate and an energy ray curable adhesive layer formed thereon, wherein the energy ray curable adhesive layer contains an acrylic adhesive polymer (A) having a weight average molecular weight of not less than 100,000 or more, and a polymerizable group is bonded to the acrylic adhesive polymer (A) through a polyalkyleneoxy group.

### [Acrylic Adhesive Polymers (A)]

The structures of the main skeletons of the acrylic adhesive polymers (A) are not particularly limited, and various acrylic copolymers used as the adhesives may be employed. The polyalkyleneoxy group is represented by —(—R—O)ₘ—. Here, R is an alkylene group, preferably an alkylene group having 1 to 6 carbon atoms, and particularly preferably an alkylene group having 2 or 3 carbon atoms. Among the alkylene groups having 1 to 6 carbon atoms, ethylene, propylene, butylene and tetramethylene are preferred, and ethylene and propylene are particularly preferred. The letter m is preferably in the range of 2 to 6, and more preferably 2 to 4. The polymerizable group refers to, for example, a group an energy ray polymerizable carbon-carbon double bond, and as specific examples, (meth) acryloyl group or so may be mentioned.

Therefore, the acrylic adhesive polymer (A) used in the invention preferably has a polymerizable group-containing polyalkyleneoxy group of Formula (1) below bonded to the side chain thereof.

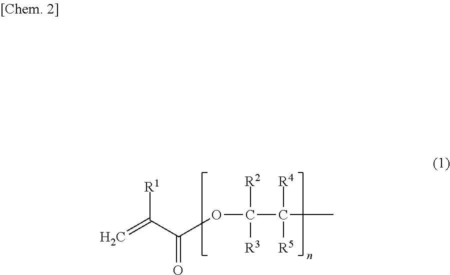

In the above formula, R¹ is a hydrogen atom or a methyl group, and preferably a methyl group; R² to R⁵ are each independently a hydrogen atom or an alkyl group having 1 to 4 carbon atoms, preferably a hydrogen atom; and n is an integer of 2 or greater, further preferably from 2 to 4. The plurality of R² to R⁵ may be the same or different from each other. That is, because n is 2 or greater, the polymerizable group-containing polyalkyleneoxy group of Formula (1) includes two or more R². Hence, the two or more R² may be the same or different from one another. The same applies to R³ to R⁵.

The acrylic adhesive polymers (A) have a weight average molecular weight of 100,000 or more, preferably in the range of 100,000 to 1,500,000, and particularly preferably 150,000 to 1,000,000. Also, the number of the polymerizable group-containing polyalkyleneoxy groups contained per 100 g of the acrylic adhesive polymer (A) is usually 1×10²² to 1×10²⁴, preferably 2×10²² to 5×10²³, and particularly preferably 3×10²² to 1×10²³. The acrylic adhesive polymers (A) usually have a glass transition temperature of about −70 to 10° C.

The acrylic adhesive polymer (A) formed by a polymerizable group-containing polyalkyleneoxy group bonded to the side chain is obtained by reacting an acrylic copolymer (a1) having functional group-containing monomer units and a polymerizable group-containing polyalkyleneoxy compound (a2) having a substituent group capable of reacting with the functional group.

The functional group-containing monomer has a polymerizable double bond and a functional group such as hydroxyl group, carboxyl group, amino group, substituted amino group and epoxy group or so in the molecule. Hydroxyl group-containing unsaturated compounds and carboxyl group-containing unsaturated compounds are preferably used.

Specific examples of such functional group-containing monomers include hydroxyl group-containing acrylates such as 2-hydroxyethyl acrylate, 2-hydroxyethyl methacrylate, 2-hydroxypropyl acrylate, 2-hydroxypropyl methacrylate, 2-hydroxybutyl acrylate and 2-hydroxybutyl methacrylate or so, and carboxyl group-containing compounds such as acrylic acid, methacrylic acid and itaconic acid or so.

The above mentioned functional group-containing monomers may be used alone, or two or more thereof may be used in combination. The acrylic copolymer (a1) is composed of structural units derived from the above functional group-containing monomer and structural units derived from a (meth)acrylate monomer or a derivative thereof. As for the (meth)acrylate monomers, alkyl(meth)acrylates in which the alkyl groups have 1 to 18 carbon atoms is used. As the derivatives of (meth)acrylate monomers, dialkyl(meth)acrylamides such as dimethylacrylamide, dimethylmethacrylamide, diethylacrylamide and diethylmethacrylamide or so may be mentioned. Among these, methyl acrylate, methyl methacrylate, ethyl acrylate, ethyl methacrylate, propyl acrylate, propyl methacrylate, butyl acrylate, butyl methacrylate, 2-ethylhexyl acrylate, 2-ethylhexyl methacrylate and dimethylacrylamide are particularly preferable.

The acrylic copolymers (a1) usually contain the structural units derived from the above mentioned functional group-containing monomer at 3 to 100 wt %, preferably 5 to 40 wt %, particularly preferably 10 to 30 wt %; and the structural units derived from the (meth)acrylate monomer or derivative thereof at 0 to 97 wt %, preferably 60 to 95 wt %, particularly preferably 70 to 90 wt %.

The acrylic copolymers (a1) may be obtained by copolymerizing the above mentioned functional group-containing monomers and the (meth)acrylate monomers or derivatives thereof by conventional methods, however other monomers such as vinyl formate, vinyl acetate and styrene or so may be co polymerized as well.

The acrylic copolymer (a1) having the functional group-containing monomer units is reacted with a polymerizable group-containing polyalkyleneoxy compound (a2) having a substituent group capable of reacting with the functional group, thereby the acrylic adhesive polymer (A) can be obtained.

The polymerizable group-containing polyalkyleneoxy compounds (a2) includes a substituent group capable of reacting with the functional group in the acrylic copolymer (a1). These substituent groups are variable depending on the types of said functional groups. For example when the functional group is a hydroxyl group or a carboxyl group, the substituent groups are preferably an isocyanate group and an epoxy group. When the functional group is a carboxyl group, the substituent groups are preferably an isocyanate group and an epoxy group. When an amino group or a substituted amino group is the functional group, an isocyanate group is a preferred substituent group. When the functional group is an epoxy group, a carboxyl group is a preferred substituent group. Such substituent groups as described above are included in every molecule of the polymerizable group-containing polyalkyleneoxy compound (a2).

Also, the polymerizable group-containing polyalkyleneoxy compounds (a2) include 1 to 5, and preferably 1 or 2 energy ray polymerizable carbon-carbon double bonds in each molecule.

Specific examples of the polymerizable group-containing polyalkyleneoxy compounds (a2) include compounds represented by Formula (2) below:

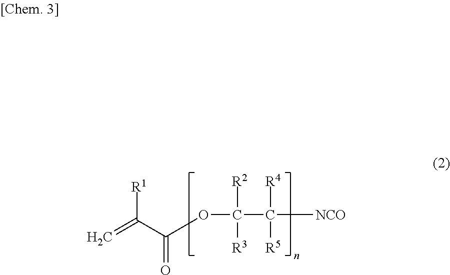

In the above formula, R¹ to R⁵ and n are as described hereinabove, and NCO indicate an isocyanate group as the substituent group.

The polymerizable group-containing polyalkyleneoxy compound (a2) is usually used in 20 to 100 equivalents, preferably 40 to 95 equivalents, and particularly preferably 60 to 90 equivalents per 100 equivalents of the functional group-containing monomer of the above mentioned acrylic copolymer (a1).

The reaction between the acrylic copolymer (a1) and the polymerizable group-containing polyalkyleneoxy compound (a2) is usually performed under room temperature or so and atmospheric pressure for approximately 24 hours. The reaction is preferably carried out by using a catalyst such as dibutyl tin laurate or so in a solvent such as ethyl acetate.

As a result, the reaction takes place between the functional group present in a side chain of the acrylic copolymer (a1) and the substituent group in the polymerizable group-containing polyalkyleneoxy compound (a2), and the polymerizable group-containing polyalkyleneoxy group is introduced in the side chain of the acrylic copolymer (a1), thereby the acrylic adhesive polymer (A) is obtained.

### [Crosslinking Agents (B)]

The energy ray curable adhesives used in the invention may be formed of the acrylic adhesive polymer (A) alone, or it may be partially crosslinked with a crosslinking agent (B). Examples of the crosslinking agents (B) include organic polyisocyanate compounds, organic polyepoxy compounds and organic polyimine compounds or so.

The above mentioned organic polyisocyanate compounds include aromatic polyisocyanate compounds, aliphatic polyisocyanate compounds, alicyclic polyisocyanate compounds, trimers of these organic polyisocyanate compounds, and isocyanate-terminated urethane prepolymers or so obtained by reacting the above organic polyisocyanate compounds with polyol compounds. Specific examples of the organic polyisocyanate compounds include 2,4-tolylene diisocyanate, 2,6-tolylene diisocyanate, 1,3-xylylene diisocyanate, 1,4-xylene diisocyanate, diphenylmethane-4,4′-diisocyanate, diphenylmethane-2,4′-diisocyanate, 3-methyldiphenylmethane diisocyanate, hexamethylene diisocyanate, isophorone diisocyanate, dicyclohexylmethane-4,4′-diisocyanate, dicyclohexylmethane-2,4′-diisocyanate, adduct of toluoylene diisocyanate with trimethylolpropane, and lysine isocyanate or so.

Examples of the organic polyepoxy compounds include bisphenol A epoxy compounds, bisphenol F epoxy compounds, 1,3-bis(N,N-diglycidylaminomethyl)benzene, 1,3-bis(N,N-diglycidylaminomethyl)toluene and N,N,N′,N′-tetraglycidyl-4,4-diaminodiphenylmethane or so.

Examples of the organic polyimine compounds include N,N′-diphenylmethane-4,4′-bis(1-aziridinecarboxyamide), trimethylolpropane-tri-β-aziridinyl propionate, tetramethylolmethane-tri-β-aziridinyl propionate and N,N′-toluene-2,4-bis(1-aziridinecarboxyamide) triethylenemelamine or so.

The used amount of the crosslinking agents (B) is preferably 0.1 to 20 parts by weight, and particularly preferably about 1 to 10 parts by weight or so with respect to 100 parts by weight of the acrylic adhesive polymer (A).

### [Photopolymerization Initiators (C)]

Also, when UV rays are used as the energy rays to cure the energy ray curable adhesive layer to use of the wafer-processing adhesive sheet of the present invention, by adding a photopolymerization initiator (C), the polymerization/curing time and irradiation dose of the rays can be reduced.

Examples of the photopolymerization initiators (C) include benzophenone, acetophenone, benzoin, benzoin methyl ether, benzoin ethyl ether, benzoin isopropyl ether, benzoin isobutyl ether, benzoin benzoate, benzoin methyl benzoate, benzoin dimethyl ketal, 2,4-diethylthioxanthone, 1-hydroxycyclohexyl phenyl ketone, benzyl diphenyl sulfide, tetramethylthiuram monosulfide, azobisisobutyronitrile, benzyl, dibenzyl, diacetyl, β-chloroanthraquinone and 2,4,6-trimethylbenzoyl diphenylphosphine oxide or so. The photopolymerization initiators (C) may be preferably used in an amount of 0.1 to 10 parts by weight, and particularly preferably 0.5 to 5 parts by weight with respect to 100 parts by weight of the acrylic adhesive polymer (A).

The adhesive layer of the adhesive sheet according to the invention is formed from the above mentioned acrylic adhesive polymer (A) and, if needed, the crosslinking agent (B) and the photopolymerization initiator (C). Also, in addition to these components, other components may be added as long as the adhesive layer maintains the property requirements described hereinabove.

### [Energy Ray Curable Adhesives]

Such energy ray curable adhesives drastically reduce the adhesive force by energy ray irradiation. UV rays and electron beams or so may be used as the energy rays.

The energy ray curable adhesive layers of the invention has sufficient adhesive force before the energy ray irradiation and reliably holds a wafer during the backgrinding of the wafer and also prevents the scattering of chips when the wafer is diced. When the adhesive is cured by the energy ray irradiation, it drastically reduces the adhesive force and comprises high breaking elongation. As a result, the cured adhesive layer shows sufficient expandability, and even when the wafer surface has numerous irregularities defined by the fine wires or circuit patterns, the cured adhesive sheet of the adhesive layer can be released from the wafer (chips) in a manner such that the cured adhesive extends without being broken by the pulling and freed from being caught in the gaps, thus the cured adhesive and the surrounding curable adhesives, can be released from the circuit surface and the glue residue can be reduced.

The adhesive layer that has been cured by the energy ray irradiation preferably has a breaking elongation of 10 to 50%, and more preferably 16 to 45%. The breaking elongation is particularly preferably in the range of 20 to 40%, when the sheet is used as a backgrinding tape, and is particularly preferably in the range of 16 to 35% when the sheet is used as a dicing tape.

Furthermore, the energy ray curable adhesive layer that has been cured by the energy ray irradiation preferably has a Young's modulus of 500 MPa or less, and more preferably in the range of 5 to 450 MPa. Also, the Young's modulus is more preferably 150 MPa or less, and particularly preferably in the range of 10 to 100 MPa when the sheet is used as a backgrind tape. Also, more preferably it is 450 MPa or less, and particularly preferably in the range of 20 to 450 MPa when the sheet is used as a dicing tape. When the adhesive layer cured by the energy ray irradiation has a breaking elongation and a Young's modulus in the above ranges, the adhesive layer can extend easily and when releasing from a wafer, at the same time sufficiently lowers the releasing force, thereby eliminating the probability of residual adhesive on a silicon wafer.

The above described energy ray curable adhesive layer is cured by the energy ray irradiation and drastically reduces the adhesive force. For example, the adhesive force to a mirror surface of a semiconductor wafer before the energy ray irradiation is preferably about 2000 to 16000 mN/25 mm, and more preferably about 5000 to 12000 mN/25 mm or so. On the other hand, after the irradiation, the adhesive force can be controlled to approximately 1 to 50% of that of before the irradiation.

Furthermore, the adhesive layer before curing preferably have a storage elastic modulus G′ (23° C.) of 0.04 to 0.3 MPa. Also it is more preferably in the range of 0.05 to 0.1 MPa when the sheet is used as a backgrind tape, and is more preferably 0.05 to 0.25 MPa when the sheet is used as a dicing tape. The loss elastic modulus/storage elastic modulus, namely the tan δ value (23° C.) is preferably in the range of 0.2 to 2. Also the value is more preferably in the range of 0.3 to 1 when the sheet is used as a backgrind tape, and is more preferably in the range of 0.25 to 1 when the sheet is used as a dicing tape. The uncured adhesive layer having the above viscoelastic properties can be applied to a wafer smoothly.

As described above, the energy ray curable adhesives of the invention comprises sufficient adhesive force to the adherends before the energy ray irradiation, while the adhesive force to the adherends is drastically reduced after the irradiated by energy rays and can be removed from the adherends without glue residue. Therefore, this energy ray curable adhesives are suitably used in applications in which the adhesives are scheduled to be peeled after applied.

### [Adhesive Sheets]

The adhesive sheets according to the present invention include the energy ray curable adhesive layer having the acrylic adhesive polymer (A) described above as a main component, and a substrate.

The substrates of the adhesive sheets in the invention are not particularly limited. However, for example, when UV rays are used as the energy rays, transparent films such as polyethylene films, polypropylene films, polybutene films, polybutadiene films, polymethylpentene films, polyvinyl chloride films, vinyl chloride copolymer films, polyethylene terephthalate films, polybutylene terephthalate films, polyurethane films, ethylene vinyl acetate films, ionomer resin films, ethylene/(meth)acrylic acid copolymer films, ethylene/(meth)acrylate copolymer films, polystyrene films, polycarbonate films and fluororesin films or so may be mentioned. Crosslinked films of these films may also be used. Multilayer films of these films also may be used.

Also, when electron beams are used as the energy rays, it is does not necessary have to be transparent; hence besides the above transparent films, colored films thereof, and nontransparent films or so may be used.

The adhesive sheets of the invention may be obtained by; applying the energy ray curable adhesive on various substrates with an appropriate thickness by the conventional methods such as a roll coater, a knife coater, a roll knife coater, a gravure coater, a die coater or a curtain coater or so, followed by drying to form an adhesive layer, then depending on the needs, a release sheet may be applied on the adhesive layer. Alternatively, the adhesive layer may be provided on a release film and may be transferred to the above substrate.

The thickness of the adhesive layers is variable depending on applications, but is usually about 3 to 50 μm, and preferably about 10 to 40 μm or so. Adhesion properties or surface protection functions may be lowered if the adhesive layers are thinner. Also, the thickness of the substrates is usually 50 to 500 μm, and preferably about 100 to 300 μm or so. Handling properties or surface protection function may be lowered if the substrates are thinner.

### [Method of Backgrinding the Electronic Components]

As an example usage of the adhesive sheets of the invention, the backgrinding method of the electronic components using the adhesive sheet will be described below using a wafer backgrinding method.

In the wafer backgrinding, the adhesive sheet is attached to a circuit surface of a semiconductor wafer on which the circuits are formed on the surface, and while the circuit surface is protected, the backside of the wafer is ground to obtain the wafer having a predetermined thickness.

The semiconductor wafers may be silicon wafers or compound semiconductor wafers such as gallium arsenide or so. The thickness of the wafers before the backside grinding formed with the predetermined circuits on the surface is not particularly limited, but is usually 650 to 750 μm or so.

During the wafer backgrinding, the adhesive sheet of the invention is attached on the circuit surface to protect the circuits on the surface. The backside grinding is carried out by the known method using a grinder and a suction table or so for fixing the wafer.

After the backgrinding, the adhesive sheet is irradiated with energy rays, thereby the adhesive is cured and reduces the adhesive force, then the adhesive sheet is released from the circuit surface. The adhesive sheets according to the invention comprises sufficient adhesive force before the energy ray irradiation and reliably hold a wafer when the wafer is background and also prevents the grinding water from entering the circuit surface. After the adhesive is cured by the energy ray irradiation, the adhesive force is drastically reduced and has high breaking elongation. As a result, even when the wafer surface has numerous irregularities or gaps defined by the fine wires or the circuit patterns, the cured adhesive that are caught in such gaps can extend without being broken and are freed from caught in the irregularities or gaps on the circuit surface, thereby the together with the surrounding cured adhesive it can be released from the circuit surface with reduced probability of glue residue on the circuit surface.

### [Dicing Method of The Dicing Electronic Components]

Also since the adhesive sheet of the present invention comprises the characteristics that the adhesive force is drastically reduced by the energy ray irradiation, it may be used as the dicing sheets for dicing the electronic components. A dicing method of the semiconductor wafers will be described below as an example.

When using as a dicing sheet, the adhesive sheet of the invention is attached to the backside of the wafer. The dicing sheets may be generally attached using a mounter having a roller. However, the attaching methods are not particularly limited thereto.

The dicing method of the semiconductor wafers is not particularly limited. As an example when dicing the wafer, a peripheral portion of the dicing tape is fixed by a ring frame and the wafer is diced into chips by conventional means using a rotating blade of a dicer or so. Alternatively, the wafer may be diced with laser beams.

Next, the adhesive sheet is irradiated with the energy rays for curing and reduces the adhesive force, and then the chips are picked up from the adhesive sheet. Prior to the pickup of the chips, the adhesive sheet may be expanded to increase the spaces between the chips. The adhesive sheets of the invention have sufficient expandability even after the adhesive layer is cured, and therefore the spaces between the chips may be expanded without breaking. The chips that have been picked up are thereafter die-bonded and resin-sealed according to conventional methods; thereby the semiconductor devices are manufactured. According to the adhesive sheets of the invention, the probability of glue residue on the backside of chips is reduced, and adverse effects caused by the residual matters on the backside of the chips are avoided.

### [Other Embodiments for Use]

The adhesive sheets of the invention may be used as dicing/die-bonding purpose sheets. In such cases, the adhesive layer comprises a thermosetting resin such as epoxy or so and a curing accelerator for the thermosetting resin, in addition to the acrylic adhesive polymer (A), the crosslinking agent (B) and the photopolymerization initiator (C). As the substrate, a film having 40 mN/m or less of the surface tension of a surface on which the adhesive layer is formed, is preferably used.

When the adhesive sheet is used as a dicing/die-bonding dual purpose sheet, the sheet is fixed on a dicing apparatus by a ring frame, a surface of a semiconductor wafer is placed on the adhesive layer of the sheet, and the wafer is lightly pressed and fixed.

Then, the wafer is cut with cutting means such as a dicing saw or so to obtain IC chips. At the same time, the adhesive layer is cut. Subsequently, the adhesive layer is irradiated with the energy rays. Then, depending on the needs, the expansion is performed. The IC chips are then picked up, thereby the adhesive layer that has been cut remains attached on the backside of the respective IC chips.

The IC chip is mounted on a die pad through the adhesive layer and is heated. The heating causes the thermosetting resin to exhibit adhesive force, and thereby the IC chip and the die pad are strongly bonded together.

Although the adhesive sheets of the invention are described with respect to semiconductor wafer backgrinding and dicing, the adhesive sheets may be used for the processing of not only the semiconductor wafers but also other electronic components and members such as various electronic device packages, glass, ceramics, green ceramics and compound semiconductors or so.

### EXAMPLES

The present invention will be described based on examples hereinbelow, however the scope of the invention is not limited to such examples. The amounts (contents) of components are all in terms of solid unless otherwise specified.

### Example 1

### Preparation of the Energy Ray Curable Adhesive

73.2 parts by weight of butyl acrylate, 10 parts by weight of dimethylacrylamide and 16.8 parts by weight of 2-hydroxyethyl acrylate as a functional group-containing monomer were solution polymerized in ethyl acetate solvent to give an acrylic copolymer having a weight average molecular weight of 500,000. 100 parts by weight of this acrylic copolymer was reacted with 24 parts by weight of a polymerizable group-containing polyalkyleneoxy compound (2-(2-methacryloyloxyethyloxy)ethyl isocyanate) illustrated below (83 equivalents with respect to 100 equivalents of the hydroxyl groups as the functional groups of the acrylic copolymer) to obtain an acrylic adhesive polymer in which polymerizable groups were bonded through the polyalkyleneoxy groups (5.8×10²² polymerizable group-containing polyalkyleneoxy groups were contained per 100 g of the acrylic adhesive polymer.).

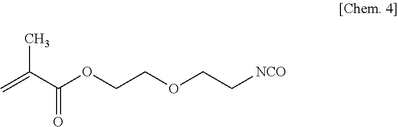

With respect to 100 parts by weight of the acrylic adhesive polymer, 2.0 parts by weight of a polyisocyanate compound (CORONATE L (manufactured by Nippon Polyurethane Industry Co., Ltd.)) as a crosslinking agent and 3.3 parts by weight of IRGACURE 184 (manufactured by Ciba Specialty Chemicals) as a photopolymerization initiator were mixed, thereby an energy ray curable adhesive composition were obtained.

### Preparation of the Adhesive Sheet

The energy ray curable adhesive composition was dissolved in a solvent (ethyl acetate) to give a 30 wt % solution, then the solution was applied on a release-treated surface of a silicone release-coated polyethylene terephthalate film (thickness: 38 μm) as a release sheet, using a roll knife coater so that the thickness of the coating after drying is 40 μm, followed by drying at 120° C. for 1 minute, and a polyethylene film having the thickness of 110 μm was stacked thereon. Thereby an adhesive sheet was obtained.

### [Adhesive Force]

The adhesive force of the adhesive sheet was measured as follows.

The adhesive force of the adhesive sheet before energy ray curing was measured in accordance with JIS 20237 except that the adherend was a mirror surface of a silicon wafer, using a universal tensile tester (TENSILON/UTM-4-100 manufactured by ORIENTEC Co., LTD.) at a release rate of 300 mm/min and a release angle of 180°.

Also, the adhesive sheet was applied to a mirror surface of a silicon wafer and was left at 23° C. and under the atmosphere of 65% RH for 20 minutes. The adhesive sheet was then irradiated from the substrate side with UV rays using a UV irradiation apparatus (RAD-2000 m/12 manufactured by Lintec Corporation) (conditions: illumination intensity 230 mW/cm², light dose 180 mJ/cm²). The UV-irradiated adhesive sheet was measured as described above to determine the adhesive force after the energy ray curing.

### [Surface Contamination]

The above described adhesive sheet was used as a surface protective sheet (a backgrinding tape) in the backgrinding of the semiconductor wafer, and the surface contamination was evaluated as follows.

The adhesive sheet was applied to a circuit surface of a silicon dummy wafer (diameter: 8 inch, thickness: 725 μm) using laminator RAD-3510 manufactured by Lintec Corporation. Then, the wafer was ground to a thickness of 100 μm using a wafer backgrinding machine (DGP-8760 manufactured by DISCO Corporation). Next, the adhesive sheet was irradiated from the substrate side with UV rays using a UV irradiation apparatus (RAD-2000 m/12 manufactured by Lintec Corporation) (conditions: illumination intensity 230 mW/cm², light dose 180 mJ/cm²). Thereafter, a dicing tape (D-185 manufactured by Lintec Corporation) was applied to the ground surface using a tape mounter (RAD-2500 m/12 manufactured by Lintec Corporation), and said adhesive sheet was released from the circuit surface of the silicon dummy wafer.

Next, the circuit surface (which had been attached to the adhesive sheet) of the silicon dummy wafer was observed with a digital microscope (digital microscope VHX-200 manufactured by KEYENCE CORPORATION) at 2000 times magnification. When there were no glue residues observed, the surface contamination was evaluated as “Good”. When residues were observed, the surface contamination was evaluated as “Bad”.

The “Young's modulus” and the “breaking elongation” of the adhesive after the energy ray curing, and the “storage elastic modulus” and the “tan δ” before the energy ray curing were determined as follows.

### [Young's Modulus and Breaking Elongation]

Measurement samples were prepared as follows.

The energy ray curable adhesive composition was applied on a release-treated surface of a silicone release-coated polyethylene terephthalate film (PET film thickness: 38 μm), using a roll knife coater so that the thickness of the coating after drying is 40 μm, then it was dried at 120° C. for 1 minute, and another identical PET film was stacked thereon. Then, one of the PET films was released to expose the energy ray curable adhesive layer.

Energy ray curable adhesive layers prepared in the similar manner were sequentially stacked thereon one another until the total thickness became 200 μm. Then, the above described sample was irradiated with UV rays (conditions: illumination intensity 230 mW/cm², light dose 600 mJ/cm²) from both sides thereof for two times and was thereby cured. Then, the sample was cut to 15 mm×140 mm to give a measurement sample.

The measurement was carried out in accordance with JIS K7127 using a universal tensile tester (TENSILON/UTM-4-100 manufactured by ORIENTEC Co., LTD.) with a measurement length (a distance between chucks) of 15 mm×100 mm.

### [Storage Elastic Modulus and Tan δ]

Energy ray curable adhesive layers were sequentially stacked on one another until a total thickness became 8 mm in the same manner as described above. A cylindrical column having 8 mm diameter was punched out, thereby a measurement sample was obtained.

The storage elastic modulus and tan δ of the sample at 23° C. were measured using a viscoelasticity measuring apparatus (DYNAMIC ANALYZER RADII manufactured by REOMETRIC).

### Example 2

### Preparation of Energy Ray Curable Adhesive

80 parts by weight of butyl acrylate, 10 parts by weight of dimethylacrylamide and 10 parts by weight of 2-hydroxyethyl acrylate were solution polymerized in ethyl acetate solvent to give an acrylic copolymer having a weight average molecular weight of 680,000. 100 parts by weight of the acrylic copolymer was reacted with 13.2 parts by weight of 2-(2-methacryloyloxyethyloxy)ethyl isocyanate (77 equivalents with respect to 100 equivalents of the hydroxyl groups as the functional groups of the acrylic copolymer) to obtain an acrylic adhesive polymer in which polymerizable groups were bonded in the polymer through the polyalkyleneoxy groups (3.5×10²² polymerizable group-containing polyalkyleneoxy groups were contained per 100 g of the acrylic adhesive polymer.).

The same procedure as in Example 1 was carried out, except that the above acrylic adhesive polymer was used. The results are set forth in Table 1.

### Comparative Example 1

### Preparation of the Energy Ray Curable Adhesive

73.2 parts by weight of butyl acrylate, 10 parts by weight of dimethylacrylamide and 16.8 parts by weight of 2-hydroxyethyl acrylate were solution polymerized in ethyl acetate solvent to give an acrylic copolymer having a weight average molecular weight of 500,000. 100 parts by weight of the acrylic copolymer in terms of solid was reacted with 18.6 parts by weight of methacryloyloxyethyl isocyanate (83 equivalents with respect to 100 equivalents of the hydroxyl groups as the functional groups of the acrylic copolymer) to obtain an acrylic adhesive polymer in which polymerizable groups were bonded through the alkyleneoxy groups (6.1×10²² polymerizable group-containing polyalkyleneoxy groups were contained per 100 g of the acrylic adhesive polymer.).

The same procedure as in Example 1 was carried out, except that the above acrylic adhesive polymer was used. The results are set forth in Table 1.

### Comparative Example 2

### Preparation of the Energy Ray Curable Adhesive

62 parts by weight of butyl acrylate, 10 parts by weight of methyl methacrylate and 28 parts by weight of 2-hydroxyethyl acrylate were solution polymerized in ethyl acetate solvent to give an acrylic copolymer having a weight average molecular weight of 600,000. 100 parts by weight of the acrylic copolymer in terms of solid was reacted with 30 parts by weight of methacryloyloxyethyl isocyanate (80 equivalents with respect to 100 equivalents of the hydroxyl groups as the functional groups of the acrylic copolymer) to obtain an acrylic adhesive polymer in which polymerizable groups were bonded through the alkyleneoxy groups (8.9×10²² polymerizable group-containing polyalkyleneoxy groups were contained per 100 g of the acrylic adhesive polymer.).

The same procedure as in Example 1 carried out, except that the above acrylic adhesive polymer was used. The results are set forth in Table 1.

### Example 3

### Preparation of the Energy Ray Curable Adhesive

85 parts by weight of butyl acrylate and 15 parts by weight of 2-hydroxyethyl acrylate as a functional group-containing monomer were solution polymerized in ethyl acetate solvent to give an acrylic copolymer having a weight average molecular weight of 600,000. 100 parts by weight of the acrylic copolymer was reacted with 20.6 parts by weight of a polymerizable group-containing polyalkyleneoxy compound (2-(2-methacryloyloxyethyloxy)ethyl isocyanate) (80 equivalents with respect to 100 equivalents of the hydroxyl groups as the functional groups of the acrylic copolymer) to obtain an acrylic adhesive polymer in which polymerizable groups were bonded through the polyalkyleneoxy groups (5.16×10²² polymerizable group-containing polyalkyleneoxy groups were contained per 100 g of the acrylic adhesive polymer.).

With respect to 100 parts by weight the acrylic adhesive polymer, 0.45 part by weight of a polyisocyanate compound (CORONATE L (manufactured by Nippon Polyurethane Industry Co., Ltd.)) as a crosslinking agent and 3 parts by weight of IRGACURE 184 (manufactured by Ciba Specialty Chemicals) as a photopolymerization initiator were mixed, thereby an energy ray curable adhesive composition was obtained.

### Preparation of the Adhesive Sheet

The energy ray curable adhesive composition was dissolved in a solvent (ethyl acetate) to give a 25 wt % solution. The solution was applied on a release-treated surface of a silicone release-coated polyethylene terephthalate film which is performed with a silicone release treatment (thickness: 38 μm), using a roll knife coater so that the thickness of the coating after drying is 10 μm, then it was dried at 100° C. for 1 minute, and ethylene/methacrylic acid copolymer film having a thickness of 80 μm (copolymer weight ratio=91:9) was stacked thereon. Thereby, an adhesive sheet was obtained.

The adhesive force of the obtained adhesive sheet before and after the energy ray curing was measured as described hereinabove. Also, the “Young's modulus” and the “breaking elongation” of the adhesive after the energy ray curing, and the “storage elastic modulus” and the “tan δ” before the energy ray curing were evaluated as described hereinabove. Furthermore, the backside contamination and expandability when the adhesive sheet was used as a dicing sheet for a semiconductor wafer were evaluated as follows.

### [Backside Contamination]

The adhesive sheet was attached on the polished surface of the polished (No. 2000) silicon wafer having 6 inch diameter and 350 μm thickness using a tape mounter (RAD-2500 m/12 manufactured by Lintec Corporation). A peripheral portion of the adhesive sheet was fixed by a ring frame, and the wafer was fully cut and diced using a wafer dicing apparatus (DFD-651 manufactured by DISCO Corporation) equipped with a blade (NBC-ZH205O-SE27HECC manufactured by DISCO Corporation) under conditions a depth of a cut into the adhesive sheet is 30 μm and the chip size of 10 mm×10 mm. After the dicing, the adhesive sheet was expanded using a die-bonding apparatus (die-bonder BESTEM-DO2 manufactured by Canon Machinery Inc.) with a drawdown of 3 mm, and then the chips were picked up. The chips were picked up using an ejector in which four ejector needles are arranged in a square and another ejector needle is located in the center of the square, and the pickup was carried out by pushing the chip from the backside of the adhesive sheet by allowing 100 μm of the ejection height for the four corner needles and 600 μm of the needle height for the central needle.

Next, the polished surface (which had been attached to the adhesive sheet) of the chips that had been picked up was observed with a digital microscope (digital microscope VHX-200 manufactured by KEYENCE CORPORATION) at 2000 times magnification. When there were no glue residues observed, the backside contamination was evaluated as “Good”. When residues were observed, the backside contamination was evaluated as “Bad”.

### [Expandability]

The adhesive sheet was attached on the polished surface of the polished (No. 2000) silicon wafer having 6 inch diameter and 350 μm thickness using a tape mounter (RAD-2500 m/12 manufactured by Lintec Corporation). A peripheral portion of the adhesive sheet was fixed by a ring frame, and the wafer was fully cut and diced using a wafer dicing apparatus (DFD-651 manufactured by DISCO Corporation) equipped with a blade (NBC-ZH205O-SE27HECC manufactured by DISCO Corporation) under conditions a depth of a cut into the adhesive sheet is 30 μm and the chip size of 10 mm×10 mm. After the dicing, the adhesive sheet was expanded under the following two conditions.

“Condition A”: The adhesive sheet was expanded using an expanding apparatus (die-bonder CSP-100VX manufactured by NEC Machinery Inc.) with a setting of a drawdown of 12 mm.

“Condition B”: The adhesive sheet was expanded using an expanding apparatus (semiautomatic expander ME-300B manufactured by JCM) with a setting of a drawdown of 10 mm.

The expandability was evaluated “Good” if the adhesive sheet was not broken when the dicing sheet was drawn to the predetermined drawdown, and was evaluated to “Bad” when the adhesive sheet was broken by the drawing.

### Example 4

40 parts by weight of 2-ethylhexyl acrylate, 40 parts by weight of vinyl acetate and 20 parts by weight of 2-hydroxyethyl acrylate as a functional group-containing monomer were solution polymerized in ethyl acetate solvent to give an acrylic copolymer having a weight average molecular weight of 600,000. 100 parts by weight of the acrylic copolymer was reacted with 27.4 parts by weight of a polymerizable group-containing polyalkyleneoxy compound (2-(2-methacryloyloxyethyloxy)ethyl isocyanate) (80 equivalents with respect to 100 equivalents of the hydroxyl groups as the functional groups of the acrylic copolymer) to obtain an acrylic adhesive polymer in which polymerizable groups were bonded through the polyalkyleneoxy groups (6.5×10²² polymerizable group-containing polyalkyleneoxy groups were contained per 100 g of the acrylic adhesive polymer.).

With respect to 100 parts by weight of the acrylic adhesive polymer, 1.07 parts by weight of a polyisocyanate compound (CORONATE L (manufactured by Nippon Polyurethane Industry Co., Ltd.)) as a crosslinking agent and 3 parts by weight of IRGACURE 184 (manufactured by Ciba Specialty Chemicals) as a photopolymerization initiator were mixed, thereby an energy ray curable adhesive composition was obtained.

The same procedure as in Example 3 was carried out, except that the above the energy ray curable adhesive composition was used. The results are set forth in Table 1.

### Comparative Example 3

85 parts by weight of butyl acrylate and 15 parts by weight of 2-hydroxyethyl acrylate as a functional group-containing monomer were solution polymerized in ethyl acetate solvent to give an acrylic copolymer having a weight average molecular weight of 600,000. 100 parts by weight of the acrylic copolymer was reacted with 16 parts by weight of methacryloyloxyethyl isocyanate (80 equivalents with respect to 100 equivalents of the hydroxyl groups as the functional groups of the acrylic copolymer) to obtain an acrylic adhesive polymer in which polymerizable groups were bonded through the alkyleneoxy groups (5.35×10²² polymerizable group-containing alkyleneoxy groups were contained per 100 g of the acrylic adhesive polymer.).

With respect to 100 parts by weight of the acrylic adhesive polymer, 0.45 part by weight of a polyisocyanate compound (CORONATE L (manufactured by Nippon Polyurethane Industry Co., Ltd.)) as a crosslinking agent and 3 parts by weight of IRGACURE 184 (manufactured by Ciba Specialty Chemicals) as a photopolymerization initiator were mixed, thereby an energy ray curable adhesive composition was obtained.

The succeeding procedures were performed in the same manner as in Example 3, except that the above energy ray curable adhesive composition was used. The results are set forth in Table 1.

### Comparative Example 4

40 parts by weight of 2-ethylhexyl acrylate, 40 parts by weight of vinyl acetate and 20 parts by weight of 2-hydroxyethyl acrylate as a functional group-containing monomer were solution polymerized in ethyl acetate solvent to give an acrylic copolymer having a weight average molecular weight of 600,000. 100 parts by weight of the acrylic copolymer was reacted with 21.4 parts by weight of methacryloyloxyethyl isocyanate (80 equivalents with respect to 100 equivalents of the hydroxyl groups as the functional groups of the acrylic copolymer) to obtain an acrylic adhesive polymer in which polymerizable groups were bonded through the alkyleneoxy groups (6.84×10²² polymerizable group-containing alkyleneoxy groups were contained per 100 g of the acrylic adhesive polymer.).

With respect to 100 parts by weight of the acrylic adhesive polymer, 1.07 parts by weight of a polyisocyanate compound (CORONATE L (manufactured by Nippon Polyurethane Industry Co., Ltd.)) as a crosslinking agent and 3 parts by weight of IRGACURE 184 (manufactured by Ciba Specialty Chemicals) as a photopolymerization initiator were mixed, thereby an energy ray curable adhesive composition was obtained.

The same procedure as in Example 3 was carried out, except that the above energy ray curable adhesive composition was used. The results are set forth in Table 1.

TABLE 1

| | Adhesive force | | Storage | | | | | | | |
|---|---|---|---|---|---|---|---|---|---|---|
| | (mN/25 mm) | | elastic | | Young's | Breaking | | | Expandability | |
| | Before | After | modulus | | modulus | elongation | Surface | Backside | Cond. | Cond. |
| | curing | curing | MPa | tanδ | MPa | % | contamination | contamination | A | B |
| Ex. 1 | 6800 | 410 | 0.084 | 0.35 | 69 | 25.9 | Good | — | — | — |
| Ex. 2 | 6500 | 640 | 0.083 | 0.33 | 10 | 27.8 | Good | — | — | — |
| Ex. 3 | 6800 | 200 | 0.063 | 0.26 | 22 | 20.6 | — | Good | — | Good |
| Ex. 4 | 5800 | 60 | 0.230 | 0.38 | 430 | 16.3 | — | Good | Good | — |
| Comp. | 6000 | 100 | 0.090 | 0.39 | 180 | 15.3 | Bad | — | — | — |
| Ex. 1 | | | | | | | | | | |
| Comp. | 5200 | 80 | 0.110 | 0.30 | 567 | 8.3 | Bad | — | — | — |
| Ex. 2 | | | | | | | | | | |
| Comp. | 3000 | 170 | 0.078 | 0.29 | 48 | 18.7 | — | Good | — | Bad |
| Ex. 3 | | | | | | | | | | |
| Comp. | 4500 | 70 | 0.332 | 0.58 | 800 | 9.7 | — | Good | Bad | — |
| Ex. 4 | | | | | | | | | | |

1. An adhesive sheet, comprising:
a substrate and an energy ray curable adhesive layer formed thereon,
wherein the energy ray curable adhesive layer comprises an acrylic adhesive polymer having a weight average molecular weight of not less than 100,000, and a polymerizable group is bonded to the acrylic adhesive polymer through a polyalkyleneoxy group.

2. The adhesive sheet according to claim 1, wherein the acrylic adhesive polymer has a polymerizable group-containing polyalkyleneoxy group of Formula (1) below bonded to a side chain of the polymer; 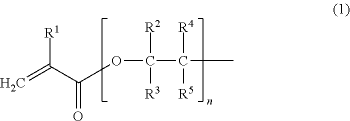
wherein R¹ is a hydrogen atom or a methyl group, R² to R⁵ are each independently a hydrogen atom or an alkyl group having 1 to 4 carbon atoms, n is an integer of 2 or greater, and a plurality of each of R² to R⁵ may be the same or different from one another.

3. The adhesive sheet according to claim 2, wherein 1×10²² to 1×10²⁴ polymerizable group-containing polyalkyleneoxy groups are contained per 100 g of the acrylic adhesive polymer.

4. The adhesive sheet according to claim 1, wherein the energy ray curable adhesive layer has a breaking elongation of 16% or more after being cured.

5. A method of backgrinding electronic components, comprising:
attaching an electronic component to the energy ray curable adhesive layer of the adhesive sheet of claim 1, and
backgrinding the electronic component.

6. A method of dicing electronic components, comprising:
attaching an electronic component to the energy ray curable adhesive layer of the adhesive sheet of claim 1, and
dicing the electronic component.
